(19) United States
(12) Patent Application Publication
(10) Pub. No.: US 2024/0291511 A1
(43) Pub. Date: Aug. 29, 2024

(54) AGGREGATE INTERFERENCE CANCELATION USING NEURAL NETWORKS

(71) Applicant: Micron Technology, Inc., Boise, ID (US)

(72) Inventors: Fa-Long Luo, San Jose, CA (US); Jaime Cummins, Bainbridge Island, WA (US)

(73) Assignee: Micron Technology, Inc., Boise, ID (US)

(21) Appl. No.: 18/584,739

(22) Filed: Feb. 22, 2024

Related U.S. Application Data
(60) Provisional application No. 63/487,576, filed on Feb. 28, 2023.

(51) Int. Cl. H04B 1/10; H04B 17/345; H04B 17/391

(52) U.S. Cl. CPC H04B 1/1036; H04B 17/345; H04B 17/3913

(57) ABSTRACT

A wireless device includes a wireless receiver configured to receive a respective plurality of receive signals from a respective receiving antenna of a plurality of receiving antennas and an interference mitigation circuit coupled to the respective receiving antenna and including a neural network. The interference mitigation circuit is configured to receive an interference mitigation mode signal indicating two or more interference types of a plurality of interference types to mitigate. In response to the interference mitigation mode signal, the interference mitigation circuit is configured to adjust weights applied by the neural network for adjusted signals to cause the neural network to mitigate the two or more interference types of the plurality of interference types while receiving the plurality of receive signals.

### CROSS REFERENCE TO RELATED APPLICATION(S)

This application claims the benefit under 35 U.S.C. § 119 of the earlier filing date of U.S. Provisional Application Ser. No. 63/487,576 filed Feb. 28, 2023, the entire contents of which are hereby incorporated by reference in their entirety for any purpose.

### BACKGROUND

In typical wireless communication systems, devices can experience many types of interference, including inter-carrier and inter-frame interference, crossband interference, self-interference (in full duplex and cross-division duplex), etc. Often, transceivers employ different interference cancellation solutions to mitigate the effects of each different type of interference, which may be serially applied to a received signal. In addition, the architectures for each solution may employ different approaches. As such, employing these solutions may increase complexity and latency.

### BRIEF DESCRIPTION OF DRAWINGS

FIG. 1 is a block diagram of a computing system arranged in accordance with examples described herein.

FIG. 2 is a block diagram of another computing system arranged in accordance with examples described herein.

FIG. 3 is a schematic illustration of a computing system arranged in accordance with examples described herein.

FIG. 4 is a flowchart of a method arranged in accordance with examples described herein.

FIG. 5 is a block diagram of a wireless communications system arranged in accordance with examples described herein.

FIG. 6 is a block diagram of another wireless communications system arranged in accordance with examples described herein.

### DETAILED DESCRIPTION

Certain details are set forth below to provide a sufficient understanding of embodiments of the present disclosure. However, it will be clear to one skilled in the art that embodiments of the present disclosure may be practiced without various of these particular details. In some instances, well-known wireless communication components, circuits, control signals, timing protocols, computing system components, and software operations have not been shown in detail in order to avoid unnecessarily obscuring the described embodiments of the present disclosure.

This disclosure describes examples of wireless communication devices in MIMO systems that use aggregated interference cancellation via one or more neural networks to mitigate effects of multiple different types of signal interference (e.g., self-interference, nonlinear interference, multiple access interference, co-channel interference (CCI), adjacent channel interference (ACI), inter-carrier and inter-frame interference, crossband interference, or combinations thereof). In some examples, a single neural network architecture design may be implemented to mitigate the different types of interference by changing weights of the neural network (e.g., operating in an individual mode). In some cases, the weights may be selected using offline training of the neural network using known data. In some other examples, the single neural network architecture may be adaptable for a full mode of operation or a partial mode of operation, where the weights are selected from training to mitigate (e.g., simultaneously mitigate) two or more different types of interference. For example, in the full mode of operation, a single neural network architecture may be configured using trained weights to mitigate all supported types of signal interference mitigation. In some other examples, in the partial mode of operation, the single neural network architecture may be configured using trained weights to mitigate some types of signal interference, and configured using other trained weights to mitigate some other types of signal interference. This may reduce complexity and latency of the system, as compared with serially applying different signal interference mitigation solutions.

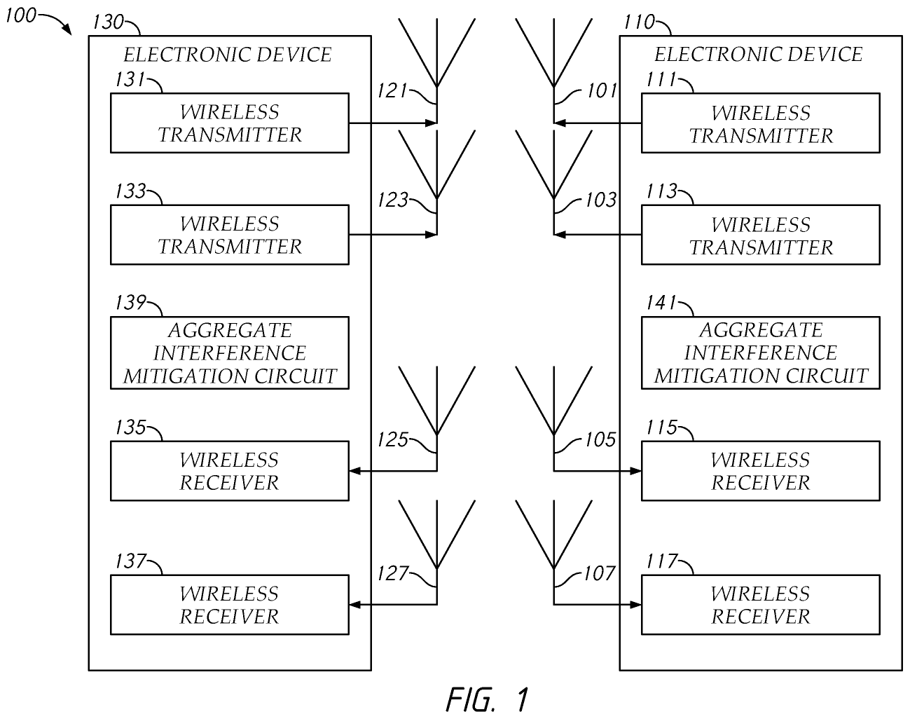

FIG. 1 is a schematic illustration of a system 100 arranged in accordance with examples described herein. System 100 includes electronic device 130, electronic device 110, antenna 101, antenna 103, antenna 105, antenna 107, antenna 121, antenna 123, antenna 125, antenna 127, wireless transmitter 111, wireless transmitter 113, wireless receiver 115, wireless receiver 117, wireless transmitter 131, wireless transmitter 133, wireless receiver 135 and, wireless receiver 137. The electronic device 130 may include antenna 121, antenna 123, antenna 125, antenna 127, wireless transmitter 131, wireless transmitter 133, wireless receiver 135, and wireless receiver 137. The electronic device 110 may include antenna 101, antenna 103, antenna 105, antenna 107, wireless transmitter 111, wireless transmitter 113, wireless receiver 115, and wireless receiver 117. In operation, electronic devices 130, 110 can communicate wireless communication signals between the respective antennas of each electronic device. In an example of a TDD mode, wireless transmitter 131 coupled to antenna 121 may transmit to antenna 105 coupled to wireless receiver 115 during an uplink period of the TDD configured radio frame, while, at the same time or during at least a portion of the same time, the wireless transmitter may also activate a switch path that provides a feedback signal to a weight calculator of wireless transmitter 131.

The weight calculator of wireless transmitter 131 may provide the weights that are utilized in a model to at least partially compensate for power amplifier noise internal to the wireless transmitter 131. The wireless transmitter 131 may include a power amplifier that amplifies wireless transmission signals before providing such respective wireless transmission signals to the antenna 121 for RF transmission. In some examples, the weight calculator wireless transmitter 131 may also provide (e.g., optimize) the weights to also at least partially compensate power amplifier noise from other components of the electronic device 130, such as a power amplifier of the wireless transmitter 133. After an uplink period of a time division duplexing (TDD) configured radio frame has passed, the wireless receiver 135 and/or the wireless receiver 137 may receive wireless signals during a downlink period of the time division duplexing configured radio frame. For example, the wireless receiver 135 and/or the wireless receiver 137 may receive individual signals or a combination of signals (e.g., a MIMO signal) from the electronic device 110, having transmitted wireless signals from the wireless transmitter 111 coupled to the antenna 101 and/or from the wireless transmitter 113 coupled to the antenna 103. Power amplifier noise may generally refer to any noise in a signal to be transmitted from an electronic device that may be at least partially generated by one or more power amplifiers of that electronic device.

Electronic devices described herein, such as electronic device 130 and electronic device 110 shown in FIG. 1 may be implemented using generally any electronic device for which communication capability is desired. For example, electronic device 130 and/or electronic device 110 may be implemented using a mobile phone, smartwatch, computer (e.g. server, laptop, tablet, desktop), or radio. In some examples, the electronic device 130 and/or electronic device 110 may be incorporated into and/or in communication with other apparatuses for which communication capability is desired, such as but not limited to, a wearable device, a medical device, an automobile, airplane, helicopter, appliance, tag, camera, or other device.

While not explicitly shown in FIG. 1, electronic device 130 and/or electronic device 110 may include any of a variety of components in some examples, including, but not limited to, memory, input/output devices, circuitry, processing units (e.g. processing elements and/or processors), or combinations thereof.

The electronic device 130 and the electronic device 110 may each include multiple antennas. For example, the electronic device 130 and electronic device 110 may each have more than two antennas. Three antennas each are shown in FIG. 1, but generally any number of antennas may be used including 2, 3, 4, 5, 6, 7, 8, 9, 10, 11, 12, 13, 14, 15, 16, 32, or 64 antennas. Other numbers of antennas may be used in other examples. In some examples, the electronic device 130 and electronic device 110 may have a same number of antennas, as shown in FIG. 1. In other examples, the electronic device 130 and electronic device 110 may have different numbers of antennas. Generally, systems described herein may include multiple-input, multiple-output (“MIMO”) systems. MIMO systems generally refer to systems including one or more electronic devices which transmit transmissions using multiple antennas and one or more electronic devices which receive transmissions using multiple antennas. In some examples, electronic devices may both transmit and receive transmissions using multiple antennas. Some example systems described herein may be “massive MIMO” systems. Generally, massive MIMO systems refer to systems employing greater than a certain number (e.g. 64) antennas to transmit and/or receive transmissions. As the number of antennas increase, so too generally does the complexity involved in accurately transmitting and/or receiving transmissions.

Although two electronic devices (e.g. electronic device 130 and electronic device 110) are shown in FIG. 1, generally the system 100 may include any number of electronic devices.

Electronic devices described herein may include receivers, transmitters, and/or transceivers. For example, the electronic device 130 of FIG. 1 includes wireless transmitter 131 and wireless receiver 135, and the electronic device 110 includes wireless transmitter 111 and wireless receiver 115. Generally, receivers may be provided for receiving transmissions from one or more connected antennas, transmitters may be provided for transmitting transmissions from one or more connected antennas, and transceivers may be provided for receiving and transmitting transmissions from one or more connected antennas. While both electronic devices 130, 110 are depicted in FIG. 1 with individual wireless transmitter and individual wireless receivers, it can be appreciated that a wireless transceiver may be coupled to antennas of the electronic device and operate as either a wireless transmitter or wireless receiver, to receive and transmit transmissions. For example, a transceiver of electronic device 130 may be used to provide transmissions to and/or receive transmissions from antenna 121, while other transceivers of electronic device 110 may be provided to provide transmissions to and/or receive transmissions from antenna 101 and antenna 103. Generally, multiple receivers, transmitters, and/or transceivers may be provided in an electronic device-one in communication with each of the antennas of the electronic device. The transmissions may be in accordance with any of a variety of protocols, including, but not limited to 5G signals, and/or a variety of modulation/demodulation schemes may be used, including, but not limited to: orthogonal frequency division multiplexing (OFDM), filter bank multi-carrier (FBMC), the generalized frequency division multiplexing (GFDM), universal filtered multi-carrier (UFMC) transmission, bi orthogonal frequency division multiplexing (BFDM), sparse code multiple access (SCMA), non-orthogonal multiple access (NOMA), multi-user shared access (MUSA) and faster-than-Nyquist (FTN) signaling with time-frequency packing. In some examples, the transmissions may be sent, received, or both, in accordance with 5G protocols and/or standards.

Examples of transmitters, receivers, and/or transceivers described herein, such as the wireless transmitter 131 and the wireless transmitter 111 may be implemented using a variety of components, including, hardware, software, firmware, or combinations thereof. For example, transceivers, transmitters, or receivers may include circuitry and/or one or more processing units (e.g. processors) and memory encoded with executable instructions for causing the transceiver to perform one or more functions described herein (e.g. software).

In some cases, antennas 121, 123, 125, and 127 and/or antennas 101, 103, 105, 107, or combinations thereof, may cause or be subject to interference. Examples of interference may include interference caused by antennas of the same device, or interference caused by other devices. Specific examples of interference may include self-interference, nonlinear interference, multiple access interference, co-channel interference (CCI), adjacent channel interference (ACI), inter-carrier and inter-frame interference, and crossband interference. To mitigate one or more of the types of interference, electronic devices 130 and 110 may include aggregate interference mitigation circuits 139 and 141, respectively. Aggregate interference mitigation circuits 139 and/or 141 may be capable of mitigating one or more of the types of interference using, for example, a single neural network architecture. The neural network architecture may be able to modify the weights generated in order to mitigate different types of interference. In some examples, the neural network architecture may use weights that are able to mitigate multiple types of interference, one type of interference, or all supported (e.g., types of interference the neural network is trained to mitigate) types of interference. The neural network architecture may be configurable in one or more modes. Such modes include a full mode of operation, a partial mode of operation, an individual mode of operation, or a combination thereof (e.g., the neural network architecture may be capable of switching modes). A full mode of operation may refer to a capability to train weights that are able to be used to mitigate all supported types of interference. A partial mode of operation may refer to a capability to train weights that are able to be used to mitigate some types of interference, and train other weights that are able to be used to mitigate some other types of interference. An individual mode of operation may refer to a capability to train weights that are able to mitigate a single type of interference, and train the weights to be different in order to mitigate each different type of interference. This may reduce complexity and latency of the system, as compared with serially applying different signal interference mitigation solutions.

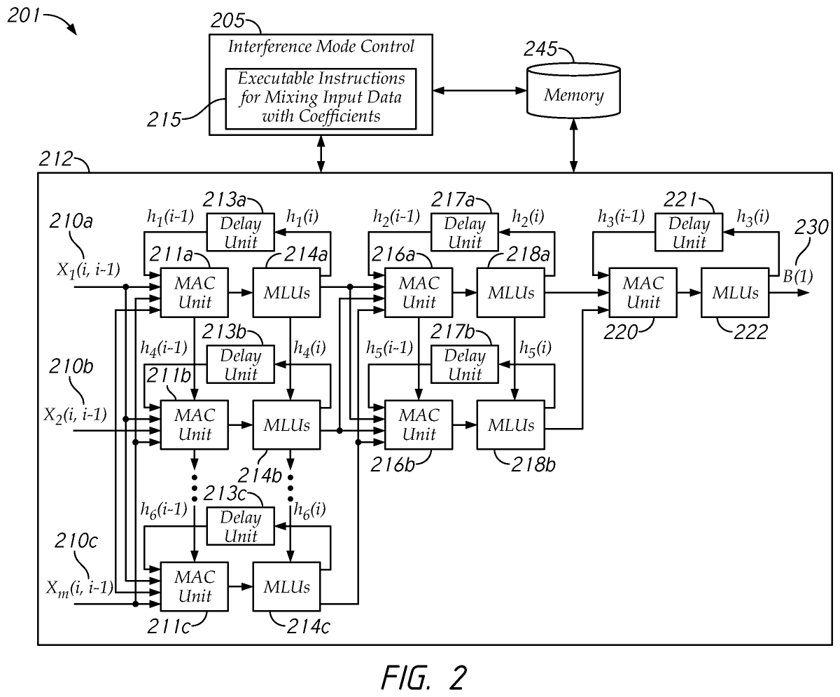

FIG. 2 is a schematic illustration of a processing unit 212 arranged in a system 201 in accordance with examples described herein. Such a hardware implementation (e.g., system 201) may be used, for example, to implement one or more neural networks, such as in the aggregate interference mitigation circuit 139 or 141. In some implementations, the processing unit 212 may receive input data 210a, 210b, and 210c from a computing system. The input data 210a, 210b, and 210c may be data to be transmitted, which may be stored in a memory 245. In some examples, data stored in the memory 245 may be input data to be transmitted from a plurality of antennas coupled to an electronic device 130 or 110 in which the processing unit 212 is implemented. In an example in which the electronic device 130 or 110 is coupled to the plurality of antennas 121, 123, 125, 127, or 101, 103, 105, 107, the input data 210a X₁(i, i−1) may correspond to a first RF transmission to be transmitted at the antenna 121, 123, 125, 127, or 101, 103, 105, 107 at a first frequency; the input data 210b X₂(i, i−1) may correspond to a second RF transmission to be transmitted at another antenna 121, 123, 125, 127, or 101, 103, 105, 107 at a second frequency; and the input data 210c Xₘ(i, i−1) may correspond to a m'th RF transmission to be transmitted at an m'th antenna at a m'th frequency. m may represent the number of antennas, with each antenna transmitting a portion of input data.

In some examples, m may also correspond to a number of wireless channels over which the input data is to be transmitted; for example, in a MIMO transmission, an RF transmission may be sent over multiple wireless channels at the plurality of antennas 101 and 103. In an example of the input data being received (in contrast to being transmitted), the input data 210a, 210b, 210c may correspond to portions of input data to be processed as an RF transmission received at multiple antennas. For example, the output data 230 B(1) may be a MIMO output signal received at the antennas 101 and 103 at an electronic device that is implementing the processing unit 212 of the computing system 201. As denoted in the representation of the input data signals, the input data 210a X₁(i, i−1) includes a current portion of the input data, at time i, and a previous portion of the input data, at time i−1. For example, a current portion of the input data may be a sample obtained at the antenna 101 at a certain time period (e.g., at time i), while a previous portion of the input data may be a sample obtained at the antenna 101 at a time period previous to the certain time period (e.g., at time i−1). Accordingly, the previous portion of the input data may be referred to as a time-delayed version of the current portion of the input data. The portions of the input data at each time period may be obtained in a vector or matrix format, for example. In an example, a current portion of the input data, at time i, may be a single value; and a previous portion of the input data, at time i−1, may be a single value. Thus, the input data 210a X₁(i, i−1) may be a vector. In some examples, the current portion of the input data, at time i, may be a vector value; and a previous portion of the input data, at time i−1, may be a vector value. Thus, the input data 210a X₁(i, i−1) may be a matrix.

Such input data, which is obtained with a current and previous portion of input data, may be representative of a Markov process, such that a causal relationship between at least the current sample and the previous sample may improve the accuracy of weight estimation for training of weight data to be utilized by the MAC units and MLUs of the processing unit 212. As noted previously, the input data 210a X₁(i, i−1) may represent data to be transmitted (e.g., transmitter output data) at a first frequency and/or data to be transmitted at a first wireless channel, including a current portion of the input data, at time i, and a previous portion of the input data, at time i−1. Accordingly, the input data 210b X₂(i, i−1) may represent data to be transmitted at a second frequency or at a second wireless channel, including a current portion of the input data, at time i, and a previous portion of the input data, at time i−1. And, the number of input signals to be transmitted by the processing unit 212 may equal in some examples to a number of antennas coupled to an electronic device 110 implementing the processing unit 212. Accordingly, the input data 210c Xₘ(i, i−1) may represent data to be transmitted at a m'th frequency or at a m'th wireless channel, including a current portion of the input data, at time i, and a previous portion of the input data, at time i−1.

The processing unit 212 may include multiplication unit/accumulation (MAC) units 211a-c, 216a-b, and 220; delay units 213a-c, 217a-b, and 221; and memory lookup units (MLUs) 214a-c, 218a-b, and 222 that, when mixed with input data to be transmitted from the memory 245, may generate output data (e.g. B (1)) 230. Each set of MAC units and MLU units having different element numbers may be referred to as a respective stage of combiners for the processing unit 212. For example, a first stage of combiners includes MAC units 211a-c and MLUs 214a-c, operating in conjunction with delay units 213a-c, to form a first stage or “layer.” Continuing in the example, the second stage of combiners includes MAC units 216a-b and MLUs 218a-b, operating in conjunction with delay units 217a-b, to form a second stage or second layer of hidden layers. And the third stage of combiners may be a single combiner including the MAC unit 220 and MLU 222, operating in conjunction with delay unit 221, to form a third stage or third layer of hidden layers.

In an example of generating RF transmission for transmission, the output data 230 B(1) may be utilized as a MIMO RF signal to be transmitted at a plurality of antennas. In an example of obtaining RF transmission that were obtained at a plurality of antennas, the output data 230 B(1) may be representative of a demodulated, decoded signal that was transmitted by another RF electronic device. In any case, the processing unit 212, may be provide instructions 215, stored at the interference mode control 205, to cause the processing unit 212 to configure the multiplication units 211a-c, 216a-c, and 220 to multiply and/or accumulate input data 210a, 210b, and 210c and delayed versions of processing results from the delay units 213a-c, 217a-b, and 221 (e.g., respective outputs of the respective layers of MAC units) with weight data to generate the output data 230 B(1). For example, the interference mode control 205 may execute instructions that cause the memory 245 to provide weights and/or other parameters stored in the memory 245, which may be associated with a certain wireless processing mode, to the MLUs 214a-c, 218a-b, and 222 as weights for the MAC units 211a-c, 216a-b, and 220 and delay units 213a-c, 217a-b, and 221. During operation, the interference mode control 205 may be used to select/adjust weights and/or other parameters in memory 245/processing unit 212 based on an indicated interference noise to calculate, e.g., the interference noise from a certain transmitting antenna to another transmitting antenna. In some cases, the interference mode control 205 may provide an interference mitigation mode signal (e.g., to memory 245, or processing unit 212) indicating two or more interference types of a plurality of interference types to mitigate. In some examples, in response to the interference mitigation mode signal, the interference mitigation circuit may be configured to adjust weights applied by the neural network for adjusted signals to cause the neural network to mitigate two or more interference types while receiving receive signals from a respective receiving antenna of a plurality of receiving antennas (e.g., 125, 127, 105, 107). In some examples, the interference mitigation mode signal may indicate a full mode of operation, wherein in the full mode of operation, the interference mitigation circuit is configured to adjust the weights in the same way, or to a common set of values, for all of the two or more interference types. In some examples, the interference mitigation mode signal indicates an individual mode of operation, wherein in the individual mode of operation, the interference mitigation circuit is configured to adjust the weights in different ways, or to a different set of values, for each of the two or more interference types. In some examples, the interference mitigation mode signal indicates a partial mode of operation, wherein in the partial mode of operation, the interference mitigation circuit is configured to adjust the weights in the same way for some of the two or more interference types, and in different ways for some other of the two or more interference types (or, adjust the weights to a first set of values for at least two of the two or more interference types, and adjust the weights to a second set of values for others of the two or more interference types). In some cases, such processes may be implemented as executable instructions for a non-transitory computer readable medium causing a wireless communication device to perform the processes.

As denoted in the representation of the respective outputs of the respective layers of MAC units (e.g., the outputs of the MLUs 214a-c, 218a-b, and 222), the input data to each MAC unit 211a-c, 216a-b, and 220 includes a current portion of input data, at time i, and a delayed version of a processing result, at time i−1. For example, a current portion of the input data may be a sample obtained at the antenna 101 at a certain time period (e.g., at time i), while a delayed version of a processing result may be obtained from the output of the delay units 213a-c, 217a-b, and 221, which is representative of a time period previous to the certain time period (e.g., as a result of the introduced delay). Accordingly, in using such input data, obtained from both a current period and at least one previous period, output data B(1) 230 may be representative of a Markov process, such that a causal relationship between at least data from a current time period and a previous time period may improve the accuracy of weight estimation for training of weight data to be utilized by the MAC units and MLUs of the processing unit 212 or inference of signals to be transmitted in utilizing the processing unit 212. As noted previously, the input data 210a X₁(i, i−1) may represent data to be transmitted (e.g., transmitter output data) at a first frequency and/or data to be transmitted at a first wireless channel, including a current portion of the input data, at time i. Accordingly, the input data 210b X₂(i, i−1) may represent data to be transmitted at a second frequency or at a second wireless channel, including a current portion of the input data, at time i. And, the number of input signals obtained by the processing unit 212 may equal in some examples to a number of antennas coupled to an electronic device 110 implementing the processing unit 212. Accordingly, the input data 210c Xm(i, i−1) may represent data obtained at an m'th frequency or at an m'th wireless channel, including a current portion of the input data, at time i. Accordingly, in utilizing delayed versions of output data from 213a-c, 217a-b, and 221 a neural network provides individualized frequency-band, time-correlation data for processing of signals to be transmitted.

In an example of executing such instructions 215 for mixing input data with weights, at a first layer of the MAC units 211a-c and MLUs 214a-c, the multiplication unit/accumulation units 211a-c are configured to multiply and accumulate at least two operands from corresponding input data 210a, 210b, or 210c and an operand from a respective delay unit 213a-c to generate a multiplication processing result that is provided to the MLUs 214a-c. For example, the multiplication unit/accumulation units 211a-c may perform a multiply-accumulate operation such that three operands, M N, and T are multiplied and then added with P to generate a new version of P that is stored in its respective MLU 214a-c. Accordingly, the MLU 214a latches the multiplication processing result, until such time that the stored multiplication processing result is provided to a next layer of MAC units. The MLUs 214a-c, 218a-b, and 222 may be implemented by any number of processing elements that operate as a memory look-up unit such as a D, T, SR, and/or JK latches.

The MLUs 214a-c, 218a-b, and 222 may generally perform a predetermined nonlinear mapping from input to output. For example, the MLUs 214a-c, 218a-b, and 222 may be used to evaluate at least one non-linear function. In some examples, the contents and size of the various MLUs 214a-c, 218a-b, and 222 depicted may be different and may be predetermined. In some examples, one or more of the MLUs 214a-c, 218a-b, and 222 may be replaced by a single consolidated MLU (e.g., a table look-up). Examples of nonlinear mappings (e.g., functions) which may be performed by the MLUs 214a-c, 218a-b, and 222 include Gaussian functions, piece-wise linear functions, sigmoid functions, thin-plate-spline functions, multi-quadratic functions, cubic approximations, and inverse multi-quadratic functions. In some examples, selected MLUs 214a-c, 218a-b, and 222 may be by-passed and/or may be deactivated, which may allow an MLU and its associated MAC unit to be considered a unity gain element.

Additionally in the example, the MLU 214a provides the processing result to the delay unit 213a. The delay unit 213a delays the processing result (e.g., h1(i)) to generate a delayed version of the processing result (e.g., h1(i−1)) to output to the MAC unit 211a as operand T. While the delay units 213a-c, 217a-b, and 221 are depicted introducing a delay of ‘1’, it can be appreciated that varying amounts of delay may be introduced to the outputs of first layer of MAC units. For example, a clock signal that introduced a sample delay of ‘1’ (e.g., h1(i−1)) may instead introduce a sample delay of ‘2’, ‘4’, or ‘100’. In various implementations, the delay units 213a-c, 217a-b, and 221 may correspond to any number of processing units that can introduce a delay into processing circuitry using a clock signal or other time-oriented signal, such as flops (e.g., D-flops) and/or one or more various logic gates (e.g., AND, OR, NOR, etc. . . . ) that may operate as a delay unit.

In the example of a first hidden layer of a neural network, the MLUs 214a-c may retrieve weight data stored in the memory 245, which may be weights associated with weights to be applied to the first layer of MAC units to both the data from the current period and data from a previous period (e.g., the delayed versions of first layer processing results). For example, the MLU 214a can be a table look-up that retrieves one or more weights (e.g., specific weights associated with a first frequency) to be applied to both operands M and N, as well as an additional weight to be applied to operand T. The MLUs 214a-c also provide the generated multiplication processing results to the next layer of the MAC units 216a-b and MLUs 218a-b. The additional layers of the MAC units 216a, 216b and MAC unit 220 working in conjunction with the MLUs 218a, 218b and MLU 222, respectively, may continue to process the multiplication results to generate the output data 230 B(n). Using such a circuitry arrangement, the output data 230 B(1) may be generated from the input data 210a, 210b, and 210c.

Advantageously, the processing unit 212 of system 201 may utilize a reduced number of MAC units and/or MLUs compared to other processing units. The number of MAC units and MLUs in each layer of the processing unit 212 is associated with a number of channels and/or a number of antennas coupled to a device in which the processing unit 212 is being implemented. For example, the first layer of the MAC units and MLUs may include m number of those units, where m represents the number of antennas, each antenna receiving a portion of input data. Each subsequent layer may have a reduced portion of MAC units, delay units, and MLUs. In some examples, a second layer of MAC units 216a-b, delay unit 217a-b, and MLUs 218a-b may include m−1 MAC units and MLUs, when m=3. Accordingly, the last layer in the processing unit 212, including the MAC unit 220, delay unit 221, and MLU 222, includes only one MAC, one delay unit, and one MLU. Because the processing unit 212 utilizes input data 210a, 210b, and 210c that may represent a Markov process, the number of MAC units and MLUs in each subsequent layer of the processing unit may be reduced, without a substantial loss in precision as to the output data 230 B(1); for example, when compared to a processing unit 212 that includes the same number of MAC units and MLUs in each layer, like that of processing unit 212 of system 201.

The weight data, for example from memory 245, can be mixed with the input data 210a-210c and delayed version of processing results to generate the output data 230 B(1). For example, the relationship of the weight data to the output data 230 B(1) based on the input data 210a-c and the delayed versions of processing results may be expressed as:

$$B ( 1 ) = {a}^{1} * f ( {\sum }_{j = 1}^{m - 1} {a}^{( m - 1 )} {f}_{j} ( {\sum }_{k = 1}^{m} {a}^{( m )} {X}_{k} ( i ) ) ) \qquad ( 1 )$$

where a(m), a(m−1), a1 are weights for the first layer of multiplication/accumulation units 211a-c and outputs of delay units 213a-c; the second layer of multiplication/accumulation units 216a-b and outputs of delay units 217a-b; and last layer with the multiplication/accumulation unit 220 and output of delay unit 221, respectively; and where f(•) is the mapping relationship which may be performed by the memory look-up units 214a-c and 218a-b. As described above, the memory look-up units 214a-c and 218a-b retrieve weights to mix with the input data and respective delayed versions of each layer of MAC units. Accordingly, the output data may be provided by manipulating the input data and delayed versions of the MAC units with the respective multiplication/accumulation units using a set of weights stored in the memory. The set of weights may be associated with vectors representative of interference noise. For example, in the case of signals to be transmitted, each weight of a set of weights may be an individual vector of interference of a respective wireless path to a first transmitting antenna of the plurality of antennas from at least one other transmitting antenna of the plurality of transmitting antennas. The set of weights may be based on connection weights obtained from the training of a neural network. The resulting mapped data may be manipulated by additional multiplication/accumulation units and additional delay units using additional sets of weights stored in the memory associated with the desired wireless protocol. The sets of weights multiplied at each stage of the processing unit 212 may represent or provide an estimation of the processing of the input data in specifically-designed hardware (e.g., an FPGA).

Further, it can be shown that the system 201, as represented by Equation (1), may approximate any nonlinear mapping with arbitrarily small error in some examples and the mapping of system 201 may be determined by the weights a(m), a(m−1), a1. For example, if such weight data is specified, any mapping and processing between the input data 210a-210c and the output data 230 may be accomplished by the system 201. For example, the weight data may represent non-linear mappings of the input data 210a-c to the output data B(1) 230. In some examples, the non-linear mappings of the weight data may represent a Gaussian function, a piece-wise linear function, a sigmoid function, a thin-plate-spline function, a multi-quadratic function, a cubic approximation, an inverse multi-quadratic function, or combinations thereof. In some examples, some or all of the memory look-up units 214a-c, 218a-b may be deactivated. For example, one or more of the memory look-up units 214a-c, 218a-b may operate as a gain unit with the unity gain. Such a relationship, as derived from the circuitry arrangement depicted in system 201, may be used to train an entity of the computing system 201 to generate weight data. For example, using Equation (1), an entity of the computing system 201 may compare input data to the output data to generate the weight data.

Each of the multiplication unit/accumulation units 211a-c, 216a-b, and 220 may include multiple multipliers, multiple accumulation units, or and/or multiple adders. Any one of the multiplication unit/accumulation units 211a-c, 216a-b, and 220 may be implemented using an ALU. In some examples, any one of the multiplication unit/accumulation units 211a-c, 216a-b, and 220 can include one multiplier and one adder that each perform, respectively, multiple multiplications and multiple additions. The input-output relationship of a multiplication/accumulation unit 211a-c, 216a-b, and 220 may be represented as:

$${B}_{o u t} = {\sum }_{i = 1}^{I} {C}_{i} * {B}_{i n} ( i ) \qquad ( 2 )$$

where “I” represents a number to perform the multiplications in that unit, Cᵢ the weights which may be accessed from a memory, such as memory 245, and Bᵢₙ(i) represents a factor from either the input data 210a-c or an output from multiplication unit/accumulation units 211a-c, 216a-b, and 220. In an example, the output of a set of multiplication unit/accumulation units, Bₒᵤₜ, equals the sum of weight data, Cᵢ multiplied by the output of another set of multiplication unit/accumulation units, Bᵢₙ(i). Bᵢₙ(i) may also be the input data such that the output of a set of multiplication unit/accumulation units, Bₒᵤₜ, equals the sum of weight data, Cᵢ multiplied by input data.

While described as a processing unit 212, it can be appreciated that the processing unit 212 may be implemented in or as any of the interference noise calculator or aggregate interference mitigation circuit (e.g., 139, 141) described herein, in operation to cancel and/or compensate interference noise via the calculation of such noise as implemented in a neural network. In such implementations, neural networks may be used to reduce and/or improve errors which may be introduced by interference noise. Advantageously, with such an implementation, wireless systems and devices implementing such neural networks increase capacity of their respective wireless networks because additional data may be transmitted in such networks, which would not otherwise be transmitted due to the effects of interference noise.

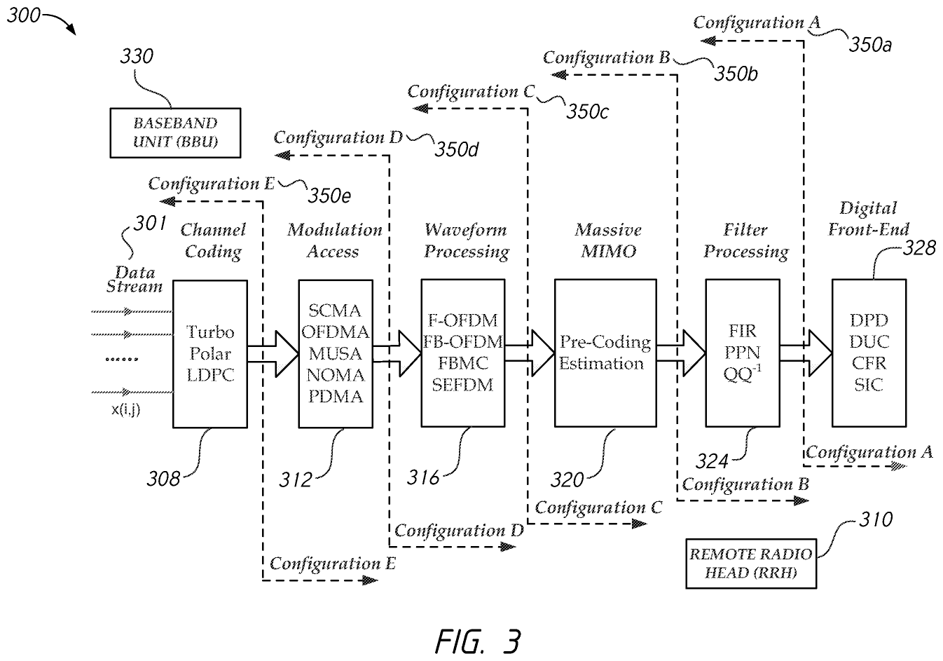

FIG. 3 is a schematic illustration of a computing system 300 arranged in accordance with examples described herein. The computing system 300 includes a baseband unit (BBU) 330 and a remote radio head (RRH) 310. While not depicted as coupled in FIG. 3, the BBU 330 and the RRH 310 may be coupled via a fronthaul link. The computing system 300 may be configured to implement various configuration modes 350a-350e, with each configuration mode allocating a wireless processing stage to either the BBU 330 or the RRH 310, as indicated by the directional dotted arrows pointing towards either the BBU 330 or the RRH 310. The computing system 300 receives input data x (i,j) 301 and performs wireless processing stages on the input data. The BBU 330 and the RRH 310 operate in conjunction upon the input data x (i,j) 301 to perform various wireless processing stages, with the operation of the wireless processing stage dependent on the configuration mode 350a-c.

The wireless processing stages of FIG. 3 include channel coding 308, modulation access 312, waveform processing 316, massive MIMO 320, filter processing 324, and digital front-end 328. Chanel coding 308 may include Turbo coding, polar coding, or low-density parity-check (LDPC) coding. It can be appreciated that channel coding 308 can include various types of channel coding. Modulation access 312 may include sparse code multiple access (SCMA), orthogonal frequency division multiple access (OFDMA), multi-user shared access (MUSA), non-orthogonal multiple access (NOMA), and/or polarization division multiple access (PDMA). Waveform processing 316 may include Filtered-Orthogonal Frequency Division Multiplexing (F-OFDM), Filter-Bank Frequency Division Multiplexing (FB-OFDM), Spectrally Efficient Frequency Division Multiplexing (SEFDM), and/or Filter Bank Multicarrier (FBMC). It can be appreciated that modulation access 312 can include various types of modulation access. The Massive MIMO 320 may include pre-coding estimation and various other functionalities associated with Massive MIMO. Filter processing 324 may include various types of digital filters, such as a finite impulse response (FIR) filter, a poly-phase network (PPN) filter, and/or QQ⁻¹ filter, which may refer to a filter that adjusts for compression and decompression of data. The digital front-end 328 may include baseband processing of a wireless transmitter or a wireless receiver. Such a digital front-end may include various functionalities for operating as a digital front-end transmitter or receiver, such as: an analog-to-digital conversion (ADC) processing, digital-to-analog (DAC) conversion processing, digital up conversion (DUC), digital down conversion (DDC), direct digital synthesizer (DDS) processing, DDC with DC offset compensation, digital pre-distortion (DPD), peak-to-average power ratio (PAPR) determinations, crest factor reduction (CFR) determinations, pulse-shaping, image rejection, delay/gain/imbalance compensation, noise-shaping, numerical controlled oscillator (NCO), and/or interference cancellation or mitigation. As such, the digital front-end may utilize one or more features from FIG. 1 or 2, such as the computing system 201, processing unit 212, and/or aggregate interference mitigation circuit 139 or 141, in order to mitigate or cancel one or more forms of signal interference.

It can be appreciated that the RRH 310 may operate as a wireless transmitter or a wireless receiver (or both as multiplexing wireless transceivers). While depicted in FIG. 3 with the RRH 310 operating as a wireless transmitter (by receiving a processed input data stream x (i,j) 301 from the BBU 330), it can be appreciated that the RRH 310 may operate as a wireless receiver that receives a transmitted wireless signal and processes that signal, according to wireless processing stages allocated to the RRH 310. The data flow may flow the opposite way to the depiction of FIG. 3, with the functionalities of the various wireless processing stages inverted. For example, in a configuration mode E 350e, the BBU 330 may receive an intermediate processing result from the RRH 310 and decode that intermediate processing result at the wireless processing stage associated with channel coding 308.

Upon determination of a configuration mode or upon receiving a configuration mode selection, the computing system 300 may allocate the wireless processing stages 308, 312, 316, 320, 324, and 328 to either the BBU 330 or the RRH 310. The configuration mode A 350a configures the RRH 310 to perform the one wireless processing stage, the digital front-end 328. In configuration mode A 350a, the other wireless processing stages, channel coding 308, modulation access 312, waveform processing 316, massive MIMO 320, and filter processing 324, are performed by the BBU 330. The computing system 300 may receive an additional configuration mode selection or determine a different configuration mode, based at least on processing times of the BBU 330 and the RRH 310. When a different configuration mode is specified, the BBU 330 and the RRH 310 may allocate processing unit(s) of each accordingly to accommodate the different configuration mode. Each configuration mode 350a-350e may be associated with a different set of weights for both the BBU 330 and the RRH 310 that is to be mixed with either the input data x (i,j) 301 or an intermediate processing result. Coefficients may be also associated with specific wireless protocols, such as 5G wireless protocols, such that the BBU 330 and the RRH 310 may be processed according to different wireless protocols. The intermediate processing results may be any processing result received by the other entity (e.g., the RRH 310 or the BBU 330), upon completion of processing by the initial entity (e.g., the BBU 330 or the RRH 310, respectively). As depicted in FIG. 3, various configuration modes 350a-350e are possible.

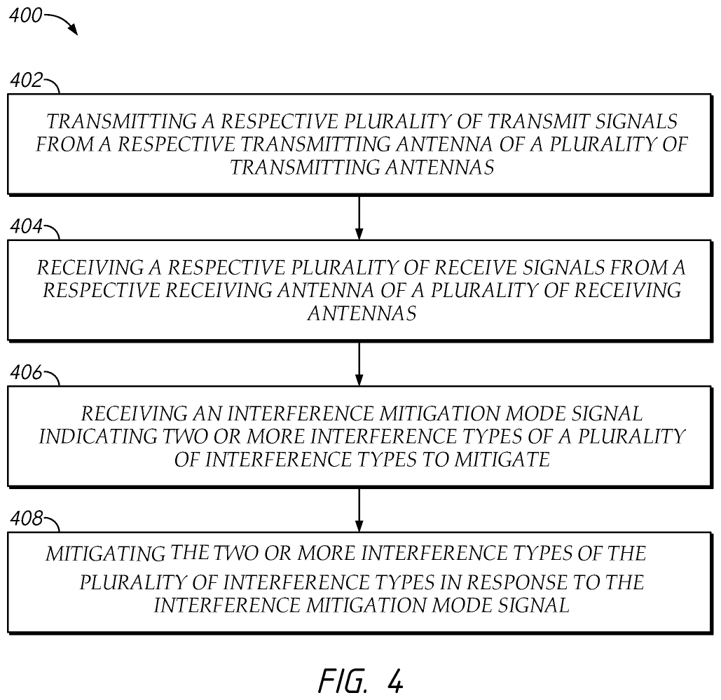

FIG. 4 is a flowchart of a method 400 in accordance with examples described herein. Example method 400 may be implemented using, for example, computing system 100 in FIG. 1, computing system 201 in FIG. 2, computing system 300 in FIG. 3, or any system or combination of the systems depicted in FIGS. 1-3 described herein. In some examples, the blocks in example method 400 may be performed by a computing system implementing processing units in the hardware platforms (e.g., a reconfigurable fabric) therein as a processing unit 212 of FIG. 2. The operations described herein may also be stored as control instructions in a computer-readable medium at an electronic device 130, 110, interference mode control 205, memory 245, processing unit 212, or in computing system 300. In some examples, various hardware platforms may implement the method 400, such as an ASIC, a DSP implemented as part of a FPGA, or a system-on-chip. In some examples, the method 400 may be implemented in a non-transitory computer readable medium comprising instructions executable to cause a wireless communication device to perform one or more of the operations of the method 400.

The method 400 may include transmitting a respective plurality of transmit signals from a respective transmitting antenna of a plurality of transmitting antennas (e.g., 121, 123, 101, 103), at 402.

The method 400 may include receiving a respective plurality of receive signals from a respective receiving antenna of a plurality of receiving antennas (e.g., 125, 127, 105, 107), at 404. In some examples, the receive signals may comprise any type of information or data or combination of types of data transmitted from another electronic communication device, including message data, telemetry data, sensor data, overhead data, etc. . . .

The method 400 may include receiving an interference mitigation mode signal (e.g., from interference mode control 205) indicating two or more interference types of a plurality of interference types to mitigate, at 406. In some examples, the interference mitigation mode signal may indicate a full mode of operation. In the full mode of operation, the interference mitigation circuit may be configured to adjust the weights in the same way for all of the two or more interference types. In some examples, the interference mitigation mode signal indicates an individual mode of operation. In the individual mode of operation, the interference mitigation circuit may be configured to adjust the weights in different ways for each of the two or more interference types. In some examples, the interference mitigation mode signal indicates a partial mode of operation. In the partial mode of operation, the interference mitigation circuit may be configured to adjust the weights in the same way for some of the two or more interference types, and in different ways for some other of the two or more interference types.

The method 400 may include, in response to the interference mitigation mode signal, mitigating the two or more interference types of the plurality of interference types while receiving the plurality of receive signals, at 408. In some examples, the method 400 may include adjusting weights by the neural network for adjusted signals in response to the interference mitigation mode signal. In some examples, the method 400 may include mixing, by a first layer of multiplication/accumulation units (MAC units) of a plurality of layers of MAC units, the plurality of transmit signals as input data and delayed versions of respective outputs of the first layer of MAC units using a plurality of weights to generate first intermediate processing results, and mixing, by each additional layer of additional layers of MAC units of the plurality of layers of MAC units, the first intermediate processing results and delayed versions of respective outputs of the respective additional layer of MAC units using additional weights of the plurality of weights to generate second intermediate processing results. In some examples, the method 400 may include providing the adjusted signals as output data, the output data based partly on the second intermediate processing results, and receiving a corresponding adjusted signal of the plurality of adjusted signals. In some examples, a number of the plurality of layers of MAC units corresponds to a number of transmitting antennas of the plurality of transmitting antennas.

The steps 402, 404, 406, and 408 of the method 400 are for illustration purposes. In some examples, the steps 402, 404, 406, and 408 may be performed in a different order. In some other examples, various steps 402, 404, 406, and 408 may be eliminated. In still other examples, various steps 402, 404, 406, and 408 may be divided into additional steps, supplemented with other steps, or combined together into fewer steps. Other variations of these specific steps 402, 404, 406, and 408 are contemplated, including changes in the order of the steps, changes in the content of the steps being split or combined into other steps, etc.

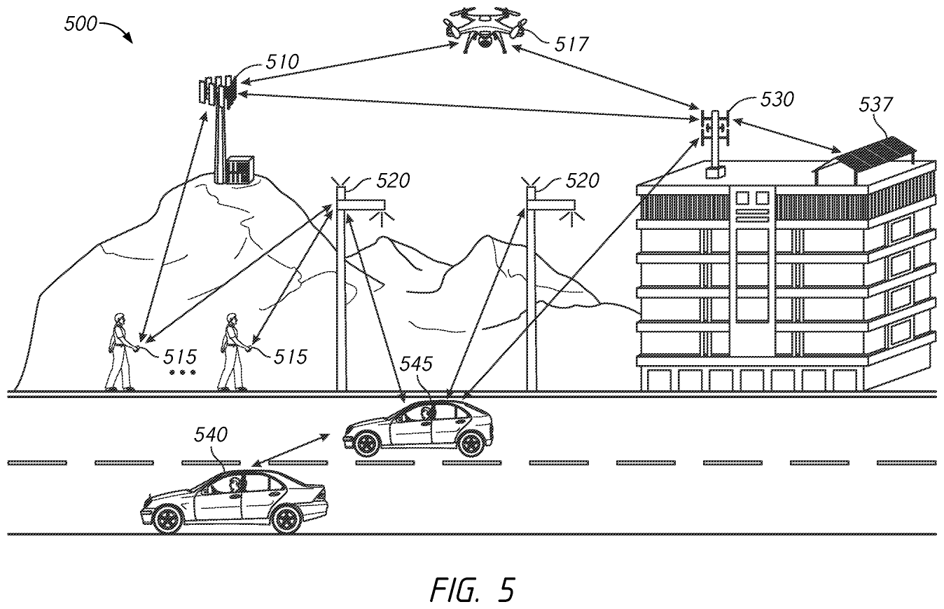

FIG. 5 illustrates an example of a wireless communications system 500 in accordance with aspects of the present disclosure. The wireless communications system 500 includes a base station 510, a mobile device 515, a drone 517, a small cell 530, and vehicles 540, 545. The base station 510 and small cell 530 may be connected to a network that provides access to the Internet and traditional communication links. The system 500 may facilitate a wide-range of wireless communications connections in a 5G wireless system that may include various frequency bands, including but not limited to: a sub-6 GHz band (e.g., 500 MHZ communication frequency), mid-range communication bands (e.g., 2.4 GHZ), and mmWave bands (e.g., 24 GHz).

Additionally or alternatively, the wireless communications connections may support various modulation schemes, including but not limited to: filter bank multi-carrier (FBMC), the generalized frequency division multiplexing (GFDM), universal filtered multi-carrier (UFMC) transmission, bi-orthogonal frequency division multiplexing (BFDM), sparse code multiple access (SCMA), non-orthogonal multiple access (NOMA), multi-user shared access (MUSA), and faster-than-Nyquist (FTN) signaling with time-frequency packing. Such frequency bands and modulation techniques may be a part of a standards framework, such as Long Term Evolution (LTE) or other technical specification published by an organization like 3GPP or IEEE, which may include various specifications for subcarrier frequency ranges, a number of subcarriers, uplink/downlink transmission speeds, TDD/FDD, and/or other aspects of wireless communication protocols.

The system 500 may depict aspects of a radio access network (RAN), and system 500 may be in communication with or include a core network (not shown). The core network may include one or more serving gateways, mobility management entities, home subscriber servers, and packet data gateways. The core network may facilitate user and control plane links to mobile devices via the RAN, and it may be an interface to an external network (e.g., the Internet). Base stations 510, communication devices 520, and small cells 530 may be coupled with the core network or with one another, or both, via wired or wireless backhaul links (e.g., S1 interface, X2 interface, etc.).

The system 500 may provide communication links connected to devices or “things,” such as sensor devices, e.g., solar cells 537, to provide an Internet of Things (“IoT”) framework. Connected things within the IoT may operate within frequency bands licensed to and controlled by cellular network service providers, or such devices or things may. Such frequency bands and operation may be referred to as narrowband IoT (NB-IoT) because the frequency bands allocated for IoT operation may be small or narrow relative to the overall system bandwidth. Frequency bands allocated for NB-IoT may have bandwidths of 50, 100, or 200 KHz, for example.

Additionally or alternatively, the IoT may include devices or things operating at different frequencies than traditional cellular technology to facilitate use of the wireless spectrum. For example, an IoT framework may allow multiple devices in system 500 to operate at a sub-6 GHz band or other industrial, scientific, and medical (ISM) radio bands where devices may operate on a shared spectrum for unlicensed uses. The sub-6 GHz band may also be characterized as and may also be characterized as an NB-IoT band. For example, in operating at low frequency ranges, devices providing sensor data for “things,” such as solar cells 537, may utilize less energy, resulting in power-efficiency and may utilize less complex signaling frameworks, such that devices may transmit asynchronously on that sub-6 GHz band. The sub-6 GHz band may support a wide variety of use cases, including the communication of sensor data from various sensors devices. Examples of sensor devices include sensors for detecting energy, heat, light, vibration, biological signals (e.g., pulse, EEG, EKG, heart rate, respiratory rate, blood pressure), distance, speed, acceleration, or combinations thereof. Sensor devices may be deployed on buildings, individuals, and/or in other locations in the environment. The sensor devices may communicate with one another and with computing systems which may aggregate and/or analyze the data provided from one or multiple sensor devices in the environment. Such data may be used to indicate an environmental characteristic of the sensor.

In such a 5G framework, devices may perform functionalities performed by base stations in other mobile networks (e.g., UMTS or LTE), such as forming a connection or managing mobility operations between nodes (e.g., handoff or reselection). For example, mobile device 515 may receive sensor data from the user utilizing the mobile device 515, such as blood pressure data, and may transmit that sensor data on a narrowband IoT frequency band to base station 510. In such an example, some parameters for the determination by the mobile device 515 may include availability of licensed spectrum, availability of unlicensed spectrum, and/or time-sensitive nature of sensor data. Continuing in the example, mobile device 515 may transmit the blood pressure data because a narrowband IoT band is available and can transmit the sensor data quickly, identifying a time-sensitive component to the blood pressure (e.g., if the blood pressure measurement is dangerously high or low, such as systolic blood pressure is three standard deviations from norm).

Additionally or alternatively, mobile device 515 may form device-to-device (D2D) connections with other mobile devices or other elements of the system 500. For example, the mobile device 515 may form RFID, WiFi, MultiFire, Bluetooth, or Zigbee connections with other devices, including communication device 520 or vehicle 545. In some examples, D2D connections may be made using licensed spectrum bands, and such connections may be managed by a cellular network or service provider. Accordingly, while the above example was described in the context of narrowband IoT, it can be appreciated that other device-to-device connections may be utilized by mobile device 515 to provide information (e.g., sensor data) collected on different frequency bands than a frequency band determined by mobile device 515 for transmission of that information.

Moreover, some communication devices may facilitate ad-hoc networks, for example, a network being formed with communication devices 520 attached to stationary objects) and the vehicles 540, 545, without a traditional connection to a base station 510 and/or a core network necessarily being formed. Other stationary objects may be used to support communication devices 520, such as, but not limited to, trees, plants, posts, buildings, blimps, dirigibles, balloons, street signs, mailboxes, or combinations thereof. In such a system 500, communication devices 520 and small cell 530 (e.g., a small cell, femtocell, WLAN access point, cellular hotspot, etc.) may be mounted upon or adhered to another structure, such as lampposts and buildings to facilitate the formation of ad-hoc networks and other IoT-based networks. Such networks may operate at different frequency bands than existing technologies, such as mobile device 515 communicating with base station 510 on a cellular communication band.

The communication devices 520 may form wireless networks, operating in either a hierarchal or ad-hoc network fashion, depending, in part, on the connection to another element of the system 500. For example, the communication devices 520 may utilize a 500 MHZ communication frequency to form a connection with the mobile device 515 in an unlicensed spectrum, while utilizing a licensed spectrum communication frequency to form another connection with the vehicle 545. Communication devices 520 may communicate with vehicle 545 on a licensed spectrum to provide direct access for time-sensitive data, for example, data for an autonomous driving capability of the vehicle 545 on a 5.9 GHz band of Dedicated Short Range Communications (DSRC).

Vehicles 540 and 545 may form an ad-hoc network at a different frequency band than the connection between the communication device 520 and the vehicle 545. For example, for a high bandwidth connection to provide time-sensitive data between vehicles 540, 545, a 24 GHZ mmWave band may be utilized for transmissions of data between vehicles 540, 545. For example, vehicles 540, 545 may share real-time directional and navigation data with each other over the connection while the vehicles 540, 545 pass each other across a narrow intersection line. Each vehicle 540, 545 may be tracking the intersection line and providing image data to an image processing algorithm to facilitate autonomous navigation of each vehicle while each travels along the intersection line. In some examples, this real-time data may also be substantially simultaneously shared over an exclusive, licensed spectrum connection between the communication device 520 and the vehicle 545, for example, for processing of image data received at both vehicle 545 and vehicle 540, as transmitted by the vehicle 540 to vehicle 545 over the 24 GHz mm Wave band. While shown as automobiles in FIG. 5, other vehicles may be used including, but not limited to, aircraft, spacecraft, balloons, blimps, dirigibles, trains, submarines, boats, ferries, cruise ships, helicopters, motorcycles, bicycles, drones, or combinations thereof.

While described in the context of a 24 GHz mmWave band, it can be appreciated that connections may be formed in the system 500 in other mmWave bands or other frequency bands, such as 28 GHZ, 37 GHZ, 38 GHz, 39 GHz, which may be licensed or unlicensed bands. In some cases, vehicles 540, 545 may share the frequency band that they are communicating on with other vehicles in a different network. For example, a fleet of vehicles may pass vehicle 540 and, temporarily, share the 24 GHz mmWave band to form connections among that fleet, in addition to the 24 GHz mmWave connection between vehicles 540, 545. As another example, communication device 520 may substantially simultaneously maintain a 500 MHZ connection with the mobile device 515 operated by a user (e.g., a pedestrian walking along the street) to provide information regarding a location of the user to the vehicle 545 over the 5.9 GHz band. In providing such information, communication device 520 may leverage antenna diversity schemes as part of a massive MIMO framework to facilitate time-sensitive, separate connections with both the mobile device 515 and the vehicle 545. A massive MIMO framework may involve a transmitting and/or receiving devices with a large number of antennas (e.g., 12, 20, 64, 128, etc.), which may facilitate precise beamforming or spatial diversity unattainable with devices operating with fewer antennas according to legacy protocols (e.g., WiFi or LTE).

The base station 510 and small cell 530 may wirelessly communicate with devices in the system 500 or other communication-capable devices in the system 500 having at the least a sensor wireless network, such as solar cells 537 that may operate on an active/sleep cycle, and/or one or more other sensor devices. The base station 510 may provide wireless communications coverage for devices that enter its coverages area, such as the mobile device 515 and the drone 517. The small cell 530 may provide wireless communications coverage for devices that enter its coverage area, such as near the building that the small cell 530 is mounted upon, such as vehicle 545 and drone 517.

Generally, the small cell 530 may be referred to as a small cell and provide coverage for a local geographic region, for example, coverage of 200 meters or less in some examples. This may be contrasted with a macrocell, which may provide coverage over a wide or large area on the order of several square miles or kilometers. In some examples, a small cell 530 may be deployed (e.g., mounted on a building) within some coverage areas of a base station 510 (e.g., a macrocell) where wireless communications traffic may be dense according to a traffic analysis of that coverage area. For example, a small cell 530 may be deployed on the building in FIG. 5 in the coverage area of the base station 510 if the base station 510 generally receives and/or transmits a higher amount of wireless communication transmissions than other coverage areas of that base station 510. A base station 510 may be deployed in a geographic area to provide wireless coverage for portions of that geographic area. As wireless communications traffic becomes denser, additional base stations 510 may be deployed in certain areas, which may alter the coverage area of an existing base station 510, or other support stations may be deployed, such as a small cell 530. Small cell 530 may be a femtocell, which may provide coverage for an area smaller than a small cell (e.g., 100 meters or less in some examples (e.g., one story of a building)).

While base station 510 and small cell 530 may provide communication coverage for a portion of the geographical area surrounding their respective areas, both may change aspects of their coverage to facilitate faster wireless connections for certain devices. For example, the small cell 530 may primarily provide coverage for devices surrounding or in the building upon which the small cell 530 is mounted. However, the small cell 630 may also detect that a device has entered is coverage area and adjust its coverage area to facilitate a faster connection to that device.

For example, a small cell 530 may support a massive MIMO connection with the drone 517, which may also be referred to as an unmanned aerial vehicle (UAV), and, when the mobile device 515 enters it coverage area, the small cell 530 adjusts some antennas to point directionally in a direction of the vehicle 545, rather than the drone 517, to facilitate a massive MIMO connection with the vehicle, in addition to the drone 517. In adjusting some of the antennas, the small cell 530 may not support as fast as a connection to the drone 517, as it had before the adjustment. However, the drone 517 may also request a connection with another device (e.g., base station 510) in its coverage area that may facilitate a similar connection as described with reference to the small cell 530, or a different (e.g., faster, more reliable) connection with the base station 510. Accordingly, the small cell 530 may enhance existing communication links in providing additional connections to devices that may utilize or demand such links. For example, the small cell 530 may include a massive MIMO system that directionally augments a link to vehicle 545, with antennas of the small cell directed to the vehicle 545 for a specific time period, rather than facilitating other connections (e.g., the small cell 530 connections to the base station 510, drone 517, or solar cells 537). In some examples, drone 517 may serve as a movable or aerial base station.

The wireless communications system 500 may include devices such as base station 510, communication device 520, and small cell 530 that may support several connections to devices in the system 500. Such devices may operate in a hierarchal mode or an ad-hoc mode with other devices in the network of system 500. While described in the context of a base station 510, communication device 520, and small cell 530, it can be appreciated that other devices that can support several connections with devices in the network may be included in system 500, including but not limited to: macrocells, femtocells, routers, satellites, and RFID detectors.

In various examples, the elements of wireless communication system 500, such as the drone 517 and the solar cells 537, may be implemented utilizing the systems, apparatuses, and methods described herein. For example, the computing system 100 implementing the electronic device 110, may be implemented in any of the elements of communication system 500. For example, the solar cells 537 may be implemented as the electronic device 130 or 110. In the example, the drone 517 and the solar cells 537 may be implemented as the electronic device 110 and 130 communicating over narrowband IoT channels. The drone 517, being implemented as the electronic device 110 or 130, may include a sensor to detect various aerodynamic properties of the drone 517 traveling through the air space. For example, the drone 517 may include sensors to detect wind direction, airspeed, or any other sensor generally included vehicles with aerodynamic properties. The drone 517 may provide the sensor data to processing units 111 that are configured to operate for an active time period and process the sensor data over a sequence of configurations partly based on a clock signal (e.g., GMT time) that the drone 517 receives from the base station 510. The drone 517 transmits an RF signal via the antenna 101 to the base station 510 with the sensor data that was processed by processing units implementing various processing stages, as described herein. Accordingly, the drone 517 may utilize less die space on a silicon chip than conventional signal processing systems and techniques that can include additional hardware or specially-designed hardware, thereby allowing the drone 517 to be of smaller size compared to drones having such conventional signal processing systems and techniques.

In the example, the solar cells 537, being implemented as the electronic device 130 or 110, may include a photoelectric sensor to detect light on the solar cells 537. The solar cells 537 may provide that sensor data to processing units that are configured to operate for an active time period and process the sensor data over a sequence of configurations. Any of the devices described in FIG. 5 may use aggregate interference mitigation circuit 139 or 141, and consequently use neural networks and processes described in FIGS. 2-4 to mitigate interference by using different modes.

Additionally or alternatively, while described in the examples above in the context of the drone 517 and the solar cells 537, the elements of communication system 500 may be implemented as part of any of the computing systems disclosed herein, including: computing system 100 in FIG. 1, computing system 200 in FIG. 2, computing system 300 in FIG. 3, or any system or combination of the systems depicted in FIGS. 1-3 described herein.

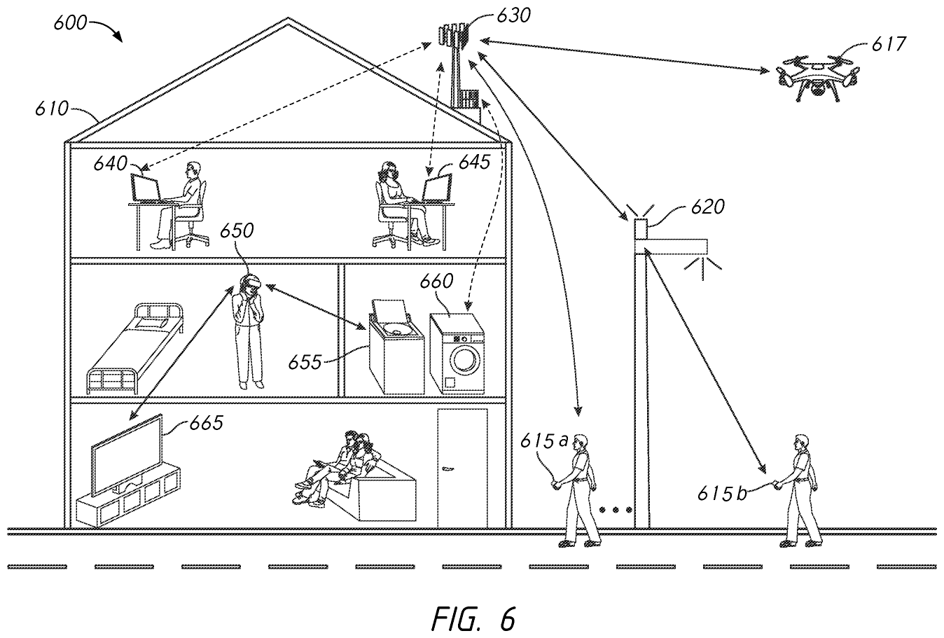

FIG. 6 illustrates an example of a wireless communications system 600 in accordance with aspects of the present disclosure. The wireless communications system 600 includes a mobile device 615, a drone 617, a communication device 620, and a small cell 630. A building 610 also includes devices of the wireless communications system 600 that may be configured to communicate with other elements in the building 610 or the small cell 630. The building 610 includes networked workstations 640, 645, virtual reality device 650, IoT devices 655, 660, and networked entertainment device 665. In the depicted wireless communications system 600, IoT devices 655, 660 may be a washer and dryer, respectively, for residential use, being controlled by the virtual reality device 650. Accordingly, while the user of the virtual reality device 650 may be in different room of the building 610, the user may control an operation of the IoT device 655, such as configuring a washing machine setting. Virtual reality device 650 may also control the networked entertainment device 665. For example, virtual reality device 650 may broadcast a virtual game being played by a user of the virtual reality device 650 onto a display of the networked entertainment device 665.

The small cell 630 or any of the devices of building 610 may be connected to a network that provides access to the Internet and traditional communication links. Like the system 500, the wireless communications system 600 may facilitate a wide-range of wireless communications connections in a 5G system that may include various frequency bands, including but not limited to: a sub-6 GHz band (e.g., 500 MHz communication frequency), mid-range communication bands (e.g., 2.4 GHZ), and mmWave bands (e.g., 24 GHZ). Additionally or alternatively, the wireless communications connections may support various modulation schemes as described above with reference to system 600. Wireless communications system 600 may operate and be configured to communicate analogously to system 500. Accordingly, similarly numbered elements of wireless communications system 600 and system 500 may be configured in an analogous way, such as communication device 520 to communication device 620, small cell 530 to small cell 630, etc.

Like the system 500, where elements of system 500 are configured to form independent hierarchal or ad-hoc networks, communication device 620 may form a hierarchal network with small cell 630 and mobile device 615, while an additional ad-hoc network may be formed among the small cell 630 network that includes drone 617 and some of the devices of the building 610, such as networked workstations 640, 645 and IoT devices 655, 660.

Devices in wireless communications system 600 may also form (D2D) connections with other mobile devices or other elements of the wireless communications system 600. For example, the virtual reality device 650 may form a narrowband IoT connections with other devices, including IoT device 655 and networked entertainment device 665. As described above, in some examples, D2D connections may be made using licensed spectrum bands, and such connections may be managed by a cellular network or service provider. Accordingly, while the above example was described in the context of a narrowband IoT, it can be appreciated that other device-to-device connections may be utilized by virtual reality device 650.

In various examples, the elements of wireless communications system 600, such as the mobile device 615, the drone 617, the communication device 620, the small cell 530, the networked workstations 640, 645, the virtual reality device 650, the IoT devices 655, 660, and the networked entertainment device 665, may be implemented as part of any of the computing system 100 in FIG. 1, computing system 200 in FIG. 2, computing system 300 in FIG. 3, or any system or combination of the systems depicted in FIGS. 1-3 described herein.

For example, the IoT device 660 may be implemented as the electronic device 130 or 110. The IoT device 655 may include a sensor to detect various acrodynamic properties of the drone 617 traveling through the air space. For example, the drone 617 may include a moisture sensor to detect a level of moisture of clothes in a residential dryer, such as IoT device 660. Any of the devices described in FIG. 6 may use aggregate interference mitigation circuit 139 or 141, and consequently use neural networks and processes described in FIGS. 2-4 to mitigate interference by using different modes.

Additionally or alternatively, while described in the examples above in the context of the IoT device 660, the elements of communication system 600 may be implemented as part of any of the computing systems disclosed herein, including: computing system 100 in FIG. 1, computing system 200 in FIG. 2, computing system 300 in FIG. 3, or any system or combination of the systems depicted in FIGS. 1-3 described herein.

Certain details are set forth above to provide a sufficient understanding of described examples. However, it will be clear to one skilled in the art that examples may be practiced without various of these particular details. The description herein, in connection with the appended drawings, describes example configurations and does not represent all the examples that may be implemented or that are within the scope of the claims. The terms “exemplary” and “example” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Techniques described herein may be used for various wireless communications systems, which may include multiple access cellular communication systems, and which may employ code division multiple access (CDMA), time division multiple access (TDMA), frequency division multiple access (FDMA), orthogonal frequency division multiple access (OFDMA), or single carrier frequency division multiple access (SC-FDMA), or any a combination of such techniques. Some of these techniques have been adopted in or related to standardized wireless communication protocols by organizations such as Third Generation Partnership Project (3GPP), Third Generation Partnership Project 2 (3GPP2) and IEEE. These wireless standards include Ultra Mobile Broadband (UMB), Universal Mobile Telecommunications System (UMTS), Long Term Evolution (LTE), LTE-Advanced (LTE-A), LTE-A Pro, New Radio (NR), IEEE 802.11 (WiFi), and IEEE 802.16 (WiMAX), among others.

The terms “5G” or “5G communications system” may refer to systems that operate according to standardized protocols developed or discussed after, for example, LTE Releases 13 or 14 or WiMAX 802.16e-2005 by their respective sponsoring organizations. The features described herein may be employed in systems configured according to other generations of wireless communication systems, including those configured according to the standards described above.

The various illustrative blocks and modules described in connection with the disclosure herein may be implemented or performed with a general-purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above are also included within the scope of computer-readable media.

Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing it will be appreciated that, although specific examples have been described herein for purposes of illustration, various modifications may be made while remaining with the scope of the claimed technology. The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus comprising:
a wireless receiver configured to receive a respective plurality of receive signals from a respective receiving antenna of a plurality of receiving antennas;
an interference mitigation circuit coupled to the respective receiving antenna and including a neural network, the interference mitigation circuit configured to receive an interference mitigation mode signal indicating two or more interference types of a plurality of interference types to mitigate, wherein, in response to the interference mitigation mode signal, the interference mitigation circuit is configured to mitigate the two or more interference types of the plurality of interference types while receiving the plurality of receive signals.

2. The apparatus of claim 1, wherein the interference mitigation circuit is configured to mitigate the two or more interference types based on adjusting weights applied by the neural network for adjusted signals.

3. The apparatus of claim 1, the interference mitigation circuit comprising:
a first layer of multiplication/accumulation units (MAC units) of a plurality of layers of MAC units configured to mix the plurality of transmit signals as input data and delayed versions of respective outputs of the first layer of MAC units using a plurality of weights to generate first intermediate processing results; and
additional layers of MAC units of the plurality of layers of MAC units, each additional layer of MAC units configured to mix the first intermediate processing results and delayed versions of respective outputs of the respective additional layer of MAC units using additional weights of the plurality of weights to generate second intermediate processing results.

4. The apparatus of claim 2, wherein the interference mitigation circuit is configured to provide the adjusted signals as output data, the output data based partly on the second intermediate processing results, and
wherein each wireless receiver is configured to receive a corresponding adjusted signal of the plurality of adjusted signals.

5. The apparatus of claim 2, wherein the interference mitigation mode signal indicates a full mode of operation, wherein in the full mode of operation, the interference mitigation circuit is configured to adjust the weights to a common set of values for all of the two or more interference types.

6. The apparatus of claim 2, wherein the interference mitigation mode signal indicates an individual mode of operation, wherein in the individual mode of operation, the interference mitigation circuit is configured to adjust the weights to a different set of values for each of the two or more interference types.

7. The apparatus of claim 2, wherein the interference mitigation mode signal indicates a partial mode of operation, wherein in the partial mode of operation, the interference mitigation circuit is configured to adjust the weights to a first set of values for at least two of the two or more interference types, and adjust the weights to a second set of values for others of the two or more interference types.

8. The apparatus of claim 1, wherein a number of the plurality of layers of MAC units corresponds to a number of transmitting antennas of the plurality of transmitting antennas.

9. A non-transitory computer readable medium comprising instructions that, when executed, cause a wireless communication device to:
receive a respective receive signal from a respective receiving antenna of a plurality of receiving antennas;
receive an interference mitigation mode signal indicating two or more interference types of a plurality of interference types to mitigate; and
in response to the interference mitigation mode signal, mitigate the two or more interference types of the plurality of interference types while receiving the receive signal.

10. The non-transitory computer readable medium of claim 9, wherein the instructions are further executable to cause the wireless communication device to mitigate the two or more interference types by adjusting weights by the neural network for adjusted signals.

11. The non-transitory computer readable medium of claim 9, wherein the instructions are further executable to cause the wireless communication device to:
mix, by a first layer of multiplication/accumulation units (MAC units) of a plurality of layers of MAC units of the neural network, the plurality of transmit signals as input data and delayed versions of respective outputs of the first layer of MAC units using a plurality of weights to generate first intermediate processing results; and
mix, by each additional layer of additional layers of MAC units of the plurality of layers of MAC units, the first intermediate processing results and delayed versions of respective outputs of the respective additional layer of MAC units using additional weights of the plurality of weights to generate second intermediate processing results.

12. The non-transitory computer readable medium of claim 10, wherein the executable instructions are further configured to cause the wireless communication device to:
provide the adjusted signals as output data, the output data based partly on the second intermediate processing results, and
receive a corresponding adjusted signal of the adjusted signals.

13. The non-transitory computer readable medium of claim 10, wherein the executable instructions are further configured to cause the wireless communication device to, in response to the interference mitigation mode signal indicating a full mode of operation, adjusting the weights to a common set of values for all of the two or more interference types.

14. The non-transitory computer readable medium of claim 10, wherein the executable instructions are further configured to cause the wireless communication device to, in response to the interference mitigation mode signal indicating an individual mode of operation, adjusting the weights to different sets of values for each of the two or more interference types.

15. The non-transitory computer readable medium of claim 10, wherein the executable instructions are further configured to cause the wireless communication device to, in response to the interference mitigation mode signal indicates a partial mode of operation, adjusting the weights to a first set of values for at least two of the two or more interference types, and adjusting the weights to a second set of values for others of the two or more interference types.

16. The non-transitory computer readable medium of claim 9, wherein a number of the plurality of layers of MAC units corresponds to a number of transmitting antennas of a plurality of transmitting antennas including the respective transmitting antenna.

17. A method, comprising:
receiving a respective plurality of receive signals from a respective receiving antenna of a plurality of receiving antennas;
receiving an interference mitigation mode signal indicating two or more interference types of a plurality of interference types to mitigate; and
in response to the interference mitigation mode signal, mitigating the two or more interference types of the plurality of interference types while receiving the plurality of receive signals.

18. The method of claim 17, further comprising mitigating the two or more interference types by adjusting weights by a neural network for adjusted signals.

19. The method of claim 15, further comprising:
mixing, by a first layer of multiplication/accumulation units (MAC units) of a plurality of layers of MAC units of the neural network, the plurality of transmit signals as input data and delayed versions of respective outputs of the first layer of MAC units using a plurality of weights to generate first intermediate processing results; and
mixing, by each additional layer of additional layers of MAC units of the plurality of layers of MAC units, the first intermediate processing results and delayed versions of respective outputs of the respective additional layer of MAC units using additional weights of the plurality of weights to generate second intermediate processing results.

20. The method of claim 18, further comprising providing the adjusted signals as output data, the output data based partly on the second intermediate processing results, and
receiving a corresponding adjusted signal of the plurality of adjusted signals.

21. The method of claim 18, further comprising, in response to the interference mitigation mode signal indicating a full mode of operation, adjusting the weights to a common set of values for all of the two or more interference types.

22. The method of claim 18, further comprising, in response to the interference mitigation mode signal indicating an individual mode of operation, adjusting the weights to a different set of values for each of the two or more interference types.

23. The method of claim 18, further comprising, in response to the interference mitigation mode signal indicating a partial mode of operation, adjusting the weights to a first set of values for at least two of the two or more interference types, and adjusting the weights to a second set of values for others of the two or more interference types.
